(19) United States
(12) Patent Application Publication
(10) Pub. No.: US 2025/0061354 A1
(43) Pub. Date: Feb. 20, 2025

(54) Automated Determination of Stopping Conditions in Online Experiments

(71) Applicant: Hewlett Packard Enterprise Development LP, Spring, TX (US)

(72) Inventors: Eitan Frachtenberg, Portland, OR (US); Pedro Henrique Rocha Bruel, San Jose, CA (US); Dejan S. Milojicic, Palo Alto, CA (US)

(21) Appl. No.: 18/450,102

(22) Filed: Aug. 15, 2023

(51) Int. Cl. G06N 5/025; G06F 18/2321

(52) U.S. Cl. CPC G06N 5/025; G06F 18/2321

(57) ABSTRACT

In certain embodiments, a method includes obtaining, by a processing device, a pre-determined number of data points from an online experiment; processing, by the processing device, the data points to determine whether the data points exhibit at least one characteristic; selecting, by the processing device and in response to the data points exhibiting the at least one characteristic, a first stopping rule of a plurality of stopping rules, wherein the first stopping rule corresponds to the at least one characteristic; applying, by the processing device, the first stopping rule to determine whether a first convergence criterion is met; and stopping, when the first convergence criterion is met, the online experiment.

### BACKGROUND

An online experiment may be any experiment in which data is being collected in real time from any source. Such data may be used to derive one or more results (e.g., a prediction, an inference, etc.). However, collecting or otherwise obtaining data may incur one or more costs (e.g., time, money, compute resources, etc.).

### BRIEF DESCRIPTION OF THE DRAWINGS

Certain embodiments discussed herein will be described with reference to the accompanying drawings listed below. However, the accompanying drawings illustrate only certain aspects or implementations of embodiments described herein by way of example, and are not meant to limit the scope of the claims.

FIG. 1 illustrates a block diagram of an example system for implementing automatic determination of stopping rules for online experiments in accordance with one or more embodiments disclosed herein;

FIG. 2 illustrates an overview of an example method for automatically determining stopping conditions of an online experiment in accordance with one or more embodiments disclosed herein; and

FIG. 3 illustrates a block diagram of a computing device, in accordance with one or more embodiments of this disclosure.

### DETAILED DESCRIPTION OF ILLUSTRATIVE EMBODIMENTS

An online experiment may be any experiment in which data is being collected in real time from any source. Such data may be used to derive one or more results (e.g., a prediction, an inference, etc.). Online experiments may be used to collect data dynamically for as long as is needed to understand and summarize the data at a desired confidence level. In one or more embodiments, an online experiment is a stream of data on which one or more metrics are measured or otherwise obtained. As an example, an online experiment may include, as data, ballot information during an election, and the corresponding metric is the projected winner. As another example, an online experiment may include, as data, various baseball statistics, and the corresponding metric is the rate at which a batter gets a hit. As another example, an online experiment may include, as data, web server requests, and the corresponding metric is 95th percentile tail latency. The data collected during an online experiment may be a finite sample, which may be used to make statistical inferences, predictions, etc. regarding a larger data set. In general, larger samples of data lead to more accurate inferences, predictions, etc.

However, obtaining additional data consumes additional resources, such as compute resources and/or time. Therefore, it may be useful to determine a relevant stopping rule for an online experiment. In one or more embodiments, a stopping rule for an online experiment is a rule that indicates when data collection may stop, while still allowing for an inference or prediction to be made with a desired level of confidence. There may be various stopping rules that can be applied to determine the best time to stop an experiment, but choosing the appropriate rule may involve an understanding of the data being collected, and of statistical properties of the data. Often, such an understanding is not available before the data is collected, which may be an expensive and/or time-consuming process. Thus, determining a stopping point for an online experiment may be challenging. As an example, stopping an online experiment too early may lead to having to re-perform the experiment, or to using insufficient data, leading to incorrect inferences. As another example, stopping the online experiment too late may lead to wasted time and resources.

Embodiments disclosed herein may automate a stopping rule selection process dynamically at run time (e.g., as the data is being collected). Embodiments disclosed herein may incorporate two primary online components: data analysis to dynamically learn the patterns in the data, and statistical models to determine an appropriate stopping rule for each pattern. In one or more embodiments, as data is collected and analyzed, the model evaluates and re-evaluates the data to determine characteristics thereof in order to determine an appropriate stopping rule, and applies the appropriate stopping rule to the measured data. Therefore, embodiments disclosed herein may pre-encode expertise on stopping rules as related to data having different characteristics, and may react dynamically to changes and transient effects seen in the data.

Examples of stopping rules include, but are not limited to: stopping after a certain amount of data (e.g., number of samples) is collected, which may be relatively simple but may not be representative if the data is changing over time; stopping based on the width of a confidence interval of the mean of the metric being predicted, which may only work when the data is normally distributed or otherwise fits the distribution corresponding to the confidence interval; stopping when a null hypothesis (e.g., that a metric meets a predetermined value) is rejected (or fails to be rejected); stopping based on Bayesian hypothesis testing (e.g., high density interval (HDI)); stopping based on a regression model (e.g., Gaussian mixture models, Gaussian process regression, Bayesian linear regression, etc.), where data collection is stopped when, after a given number of samples, a mean integrated squared error relative to an observed distribution or an information-based criterion drops below a threshold, or does not drop by a threshold of new samples added; stopping based on a clustering model, where data collection is stopped after a number of clusters describing the data stops increasing; stopping based on a classification model, where a classification model is trained with existing data to classify the data set as either stop or continue to determine whether data should continue to be collected; using Extreme Value Theory, where data collection is stopped if after a given number of samples, the modeled probability of observing an extreme value or outlier drops below a threshold. Other stopping rules may be used without departing from the scope of embodiments disclosed herein.

In one or more embodiments, the various stopping rules may have different strengths and weaknesses, which may relate to the characteristics of the data being gathered and/or the metric being predicted. Some rules may stop data collection too soon or too late relative to the characteristics of the data being collected. Thus, in one or more embodiments, data being obtained in an online experiment may be evaluated to determine characteristics of the data in order to select an appropriate stopping rule based on the characteristics.

In one or more embodiments, at least a minimum amount of data is collected, which may be pre-determined. The data may be evaluated to determine characteristics of the data, including, but not limited to: whether the data is relatively constant (e.g., the difference between maximum and minimum values is less than a threshold); whether the data is generally ascending, or descending (e.g., is the data monotonic); whether the data has a normal or log-normal distribution; whether the data is unimodal or multimodal; whether the data exhibits autocorrelations, etc. In one or more embodiments, based on one or more characteristics of the data, a stopping rule is selected, if a relevant stopping rule exists for the characteristics. If no stopping rule corresponds to one or more characteristics of the data, the online experiment may continue to collect more data, with the data being re-evaluated after more data is obtained. There may be a predetermined maximum amount of data collection that may be performed without finding an appropriate stopping rule, at which point, the online experiment may be ended.

However, if a stopping rule corresponds to one or more characteristics of the data, the stopping rule may be applied to determine whether an associated convergence criterion is met. The convergence criterion may depend on one or more characteristics of the data. As an example, if the data exhibits a normal distribution, a confidence interval test may be applied to the estimated mean to detect convergence. As another example, if the data is autocorrelated, a block bootstrapping technique may be applied to determine the autocorrelation period and decide to stop. As another example, if the data is multimodal, a clustering technique may be applied to determine whether the number of clusters on the best model fit is larger than one, and whether the best model fit is good enough. Embodiments disclosed herein are not limited to the foregoing examples. In one or more embodiments, if application of the stopping rule results in a determination that an appropriate convergence criterion has been met, then the online experiment may be stopped. In one or more embodiments, if application of the stopping rule determines that the appropriate convergence criterion has not been met (e.g., the data is normally distributed, but the confidence interval of the mean of the distribution has not reached a desired level), then the online experiment may continue, more data may be collected, and after a predetermined amount of additional data is collected, the data is again evaluated to determine one or more characteristics and, if possible, selecting a relevant stopping rule.

Certain embodiments of this disclosure may improve online experiments by dynamically determining characteristics of data in real-time in order to automatically select a stopping rule corresponding to one or more characteristics of the data. The stopping rule may be applied to determine if a convergence criterion is met, and, if it is, the online experiment may be stopped. Evaluating the data in real time as it is being obtained may allow for selection of a stopping rule that is appropriate for the data, which may allow for stopping the online experiment at a time at which enough data has been obtained to make an inference or prediction within a desired level of confidence, but without spending unnecessary time and resources obtaining data beyond what is needed make the confident inference or prediction.

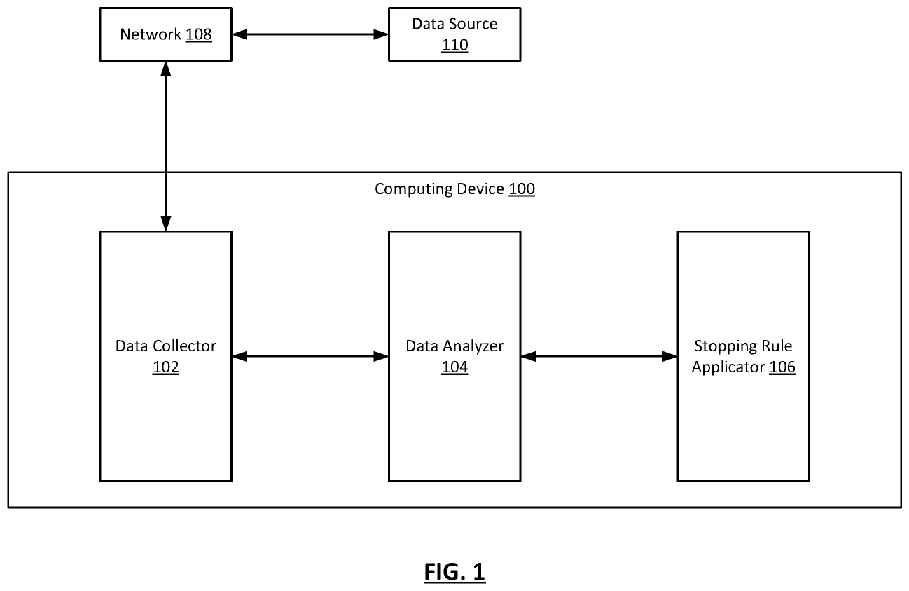

FIG. 1 illustrates a block diagram of an example system for implementing automatic determination of stopping rules for online experiments in accordance with one or more embodiments disclosed herein. The system may include a data source 110, a network 108, and a computing device 100. The computing device 100 may include a data collector 102, a data analyzer 104, and a stopping rule applicator 106, Each of these components is described below.

In one or more embodiments, as used herein, a computing device (e.g., the computing device 100) may be any single computing device, a set of computing devices, one or more portion(s) of one or more computing devices, or any other physical, virtual, and/or logical grouping of computing resources. A computing device may be referred to as an apparatus. In one or more embodiments, a computing device is any device, portion of a device, or any set of devices capable of electronically processing instructions and may include, but is not limited to, any of the following: one or more processors (e.g., components that include circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown), and/or any combination thereof.

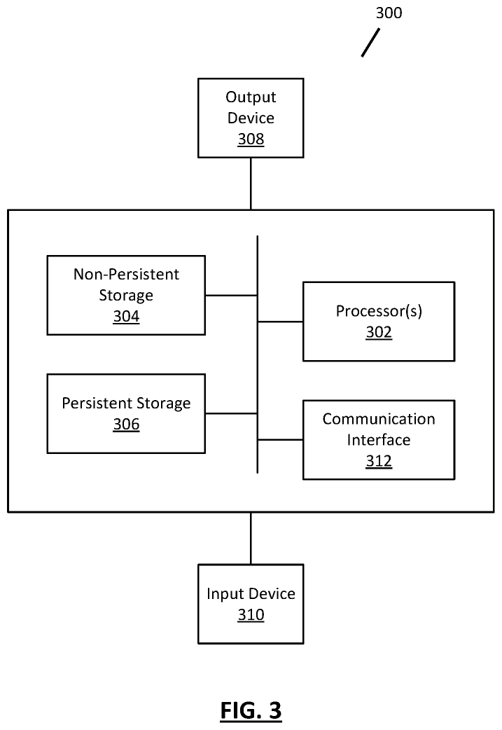

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (ISCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, a digital sensor, and/or any other type of computing device with the aforementioned requirements. In one or more embodiments, any or all of the aforementioned examples may be combined to create a system of such devices, or may be partitioned into separate logical devices, which may collectively be referred to as a computing device. Other types of computing devices may be used without departing from the scope of embodiments described herein, such as, for example, the computing device shown in FIG. 3 and described below.

In one or more embodiments, the storage (not shown) and/or memory (not shown) of a computing device or system of computing devices may be and/or include one or more data repositories for storing any number of data structures storing any amount of data (e.g., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, any storage (not shown) and/or memory (not shown) of a computing device or system of computing devices may be considered, in whole or in part, as non-transitory computer readable mediums storing software and/or firmware.

Such software and/or firmware may include instructions which, when executed by the one or more processors (not shown) and/or other hardware (e.g. circuitry) of a computing device and/or system of computing devices, cause the one or more processors and/or other hardware components to perform operations in accordance with one or more embodiments described herein.

The software instructions may be in the form of computer readable program code to perform methods, processes, etc. of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

Although FIG. 1 shows one computing device 100, one having ordinary skill in the relevant art, and the benefit of this disclosure will appreciate that the system may include any number of computing devices.

In one or more embodiments, the system includes the data source 110. The data source 110 may be any entity or device capable of generating and/or providing data to the computing device 100. As used herein, data refers to any information generated, gathered, or otherwise obtained through conducting an online experiment. An online experiment may be any experiment in which data is being obtained in real time (e.g., live), and analyzed as it is obtained, rather than after all data for the experiment is obtained. Data obtained during an online experiment may come from any one or more sources, all of which may be collectively referred to as the data source 110. The data source 110 may be one or more computing devices. The data source 110 may be an aggregator of data from other sources. The data source 110 may be a disaggregated set of entities, each separately providing obtained data. The data provided by the data source 110 may be obtained using any technique for obtaining data. As an example, the data source 110 may generate, collect, or otherwise obtain performance statistics (e.g., performance of compute resources, sports performance statistics, etc.). As another example, the data source may provide data that is being obtained during an event (e.g., ballots cast during an election). Other types of data may be obtained by the data source 110 without departing from the scope of embodiments disclosed herein. Although FIG. 1 shows the system as including a single data source 110, the system may include any number of data sources without departing from the scope of embodiments disclosed herein.

In one or more embodiments, the system includes a network 108. The network 108 may refer to an entire network or any portion thereof (e.g., a logical portion of the devices within a topology of devices). A network may include a datacenter network, a wide area network, a local area network, a wireless network, a cellular phone network, and/or any other suitable network that facilitates the exchange of information from one part of the network to another. A network may be located at a single physical location, or be distributed at any number of physical sites. In one or more embodiments, a network may be coupled with or overlap with, at least in part, the Internet. In one or more embodiments, the network 108 provides an operative connection between the data source 110 and the computing device 100. Although FIG. 1 shows an embodiment in which the network 108 operatively connects the data source 110 and the computing device 100, one of ordinary skill in the art will appreciate that the data source 110 and the computing device 100 may be operatively connected in any manner that allows for data to be provided to the computing device 100, which may or may not use a network as described above.

In one or more embodiments, the computing device 100 includes the data collector 102. The data collector 102 may be any hardware (e.g., circuitry), software, firmware, or any combination thereof that is configured to receive data (e.g., from the data source 110) that is to be processed by other components of the computing device 100. In one or more embodiments, the data collector 102 receives data from the data source 110 via the network 108. In such embodiments, the data collector 102 may be or may include a network component, such as, for example, a network interface card. The data collector 102 may receive data using any other technique without departing from the scope of embodiments disclosed herein. The data collector 102 may receive data and provide the data to other components of the computing device 100. The data collector may or may not perform some amount of initial processing of the data before it is provided to other components. As an example, the data may be provided to other components without any initial processing (e.g., raw data). As another example, the data collector 102 may perform initial processing on the data to alter the data in some way (e.g., format the data, change the format of the data, put data of various formats into a common format, transform the data into a format expected by other components of the computing device 100, etc.). Although FIG. 1 shows the computing device 100 as including a single data collector 102, the computing device 100 may include any number of data collectors without departing from the scope of embodiments disclosed herein.

In one or more embodiments, the computing device 100 includes the data analyzer 104. The data analyzer 104 may be any hardware (e.g., circuitry), software, firmware, or any combination thereof that is configured to analyze data obtained during an online experiment. In one or more embodiments, the data analyzer 104 is operatively connected to the data collector 102, from which the data analyzer 104 may receive data to analyze. In one or more embodiments, the data analyzer 104 is configured to analyze the data to assess whether the data exhibits one or more characteristics. Examples of such characteristics may include, but are not limited to, determining whether the data is constant, whether the data is monotonic, whether the data has a normal or log normal distribution, whether the data is modal, whether the data is auto-correlated, etc.

In one or more embodiments, data may be determined to be constant if all of the data is the same or within a certain threshold. As an example, if the data is numerical, and each data point is the same number, or within a one percent threshold of the same number, the data may be determined to exhibit the characteristic of being constant. In one or more embodiments, data may be determined to be monotonic if the data consistently increases or consistently decreases (e.g., numerical data that consistently increases or consistently decreases). In one or more embodiments, data may be determined to have a normal distribution when the data exhibits a Gaussian distribution around a mean, and log normal when the logarithm of the data points are distributed normally around a mean. Normal distributions have a mean and a standard deviation. In one or more embodiments, data may be determined to be modal if the set of data points of the data exhibit one or more modes. Data with more than one mode may be referred to as multi-modal. In one or more embodiments, data may be determined to be auto-correlated when the data exhibits a detectable pattern over time that repeats. As an example, the number of users accessing a website over time may vary over the course of a day, but data for many days may show that the number of users spikes during the same portion of the day in a repeating pattern.

In one or more embodiments, the data analyzer 104 is configured to analyze data received from the data collector 102 in any time frame and/or for pre-configured amounts of data. As an example, the data analyzer 104 may be configured to analyze the data after a certain amount of time has passed during the data collection, or after a certain number of data points have been collected since the start of an online experiment. In one or more embodiments, the data analyzer 104 is configured to re-analyze the data from time to time. For example, if a determination is made that the online experiment may not yet be stopped, then the data analyzer 104 may be configured to re-analyze the data after a certain amount more data is collected. Re-analysis of the data by the data analyzer 104 may be performed at pre-configured intervals of time or amounts of data. In one or more embodiments, the data analyzer 104 is configured to re-analyze data from time to time based at least in part on the previous analysis of the data (e.g., based on previously determined characteristics of the data). In one or more embodiments, the data analyzer 104 stops an analysis of the data after one or more characteristics of the data are determined, or when a determination is made that no characteristics may be determined from the data so far obtained (e.g., when the data is random). As an example, the data analyzer 104 may test the data to determine if the data exhibits a first characteristic (e.g., is the data constant), and when the data does not exhibit the first characteristic, test the data to determine another characteristic (e.g., is it monotonic, normally distributed, modal, auto-correlated, have a long tail distribution, etc.). In one or more embodiments, the data analyzer 104 is configured to determine whether the data has more than one characteristic. As an example, the data analyzer 104 may be configured to, after determining that a sample of data obtained during an online experiment is multi-modal, determine if the data is also auto-correlated. In one or more embodiments, the data analyzer 104 is configured to provide the one or more characteristics determined about the data, or the fact that no characteristics were determined, to a stopping rule applicator (discussed below).

In one or more embodiments, the computing device 100 includes the stopping rule applicator 106. In one or more embodiments, the stopping rule applicator 106 is operatively connected to the data analyzer 104. The stopping rule applicator 106 may be any hardware (e.g., circuitry), software, firmware, or any combination thereof that is configured to select a stopping rule based on the one or more characteristics, or lack of characteristics, of the data, and apply the selected stopping rule to determine if an appropriate convergence criterion is met.

As an example, if the data is determined (e.g., by the data analyzer) to be constant, the stopping rule selected may be to stop after a certain amount of data has been collected, with the amount being pre-configured based on the type of data being collected and how much data that is constant should be collected to be confident that the data will not start changing. In such an example, the convergence criterion may be that whether enough data points have been obtained.

As another example, if the data is determined to have a characteristic of being monotonic, the stopping rule may be that the online experiment may be stopped if the data has increased or decreased towards a limit, and are within a threshold of the limit, or, if the data is not converging on a limit, to stop the online experiment after a certain amount of data has been obtained but is not approaching a limit.

As another example, if the data is determined to be normally distributed, the stopping rule may be to stop the online experiment when a certain confidence interval is achieved, or based on the results of performing a t test.

As another example, if the data is determined to be multi-modal, a clustering technique may be applied to the data, and the convergence criterion may be whether the number of clusters of the best model fit is larger than one, and the best model fit's log likelihood is below a threshold.

As another example, if the data has a characteristic of being auto-correlated, the stopping test may be that the online experiment may be stopped if the correlation is seen repeatedly over a certain number of time intervals.

Other stopping rules, and related convergence criteria may be used by the stopping rule applicator 106 without departing from the scope of embodiments disclosed herein (e.g., stopping based on null hypothesis testing, stopping based on Bayesian hypothesis testing, stopping based on block bootstrapping when the data is auto-correlated, stopping based on a linear or gaussian regression model, stopping based on the results of a trained machine learning model, stopping based on testing using extreme value theory, etc.).

In one or more embodiments, if the data has no characteristic determined, the stopping rule may be to stop the online experiment after a certain amount of time has passed, or after a certain amount of data has been collected, without a characteristic being determined by the data analyzer 104.

Although FIG. 1 shows the computing device 100 as including a single stopping rule applicator 106, the computing device 100 may include any number of stopping rule applicators without departing from the scope of embodiments disclosed herein.

While FIG. 1 shows a particular configuration of components, other configurations may be used without departing from the scope of embodiments described herein. For example, although FIG. 1 shows certain components as part of the same device, any of the components may be grouped in sets of one or more components which may exist and execute as part of any number of separate and operatively connected devices. As another example, a single component may be configured to perform all or any portion of the functionality performed by the components shown in FIG. 1. Accordingly, embodiments disclosed herein should not be limited to the configuration of components shown in FIG. 1.

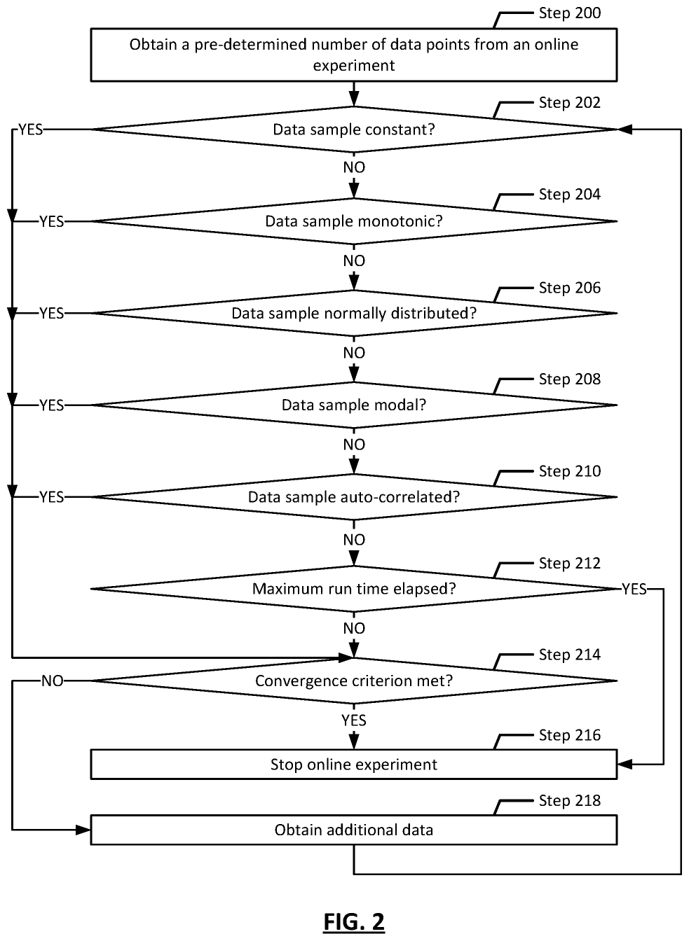

FIG. 2 illustrates an overview of an example method for automatically determining stopping conditions of an online experiment in accordance with one or more embodiments disclosed herein. The method shown in FIG. 2 may be performed, for example, by a computing device (e.g., the computing device 100 shown in FIG. 1, or the computing device 300 shown in FIG. 3), and/or any components therein (e.g., the data collector 102, the data analyzer 104, and/or the stopping rule applicator 106 shown in FIG. 1).

While the various steps in the flowchart shown in FIG. 2 are presented and described sequentially, some or all of the steps may be executed in different orders, some or all of the steps may be combined or omitted, other steps not shown in FIG. 2 may additionally be performed, and/or some or all of the steps may be executed in parallel with other steps of FIG. 2.

In Step 200, the method includes obtaining a pre-determined number of data points from an online experiment. In one or more embodiments, as an online experiment is being conducted, data is being obtained. Discrete units of the data may be referred to as data points. In one or more embodiments, the data points are obtained by a data collector (e.g., the data collector 102 shown in FIG. 1) of a computing device (e.g., the computing device 100 shown in FIG. 1, or the computing device 300 shown in FIG. 3). The data may be obtained from a data source (e.g., the data source 110 shown in FIG. 1). In one or more embodiments, the data is obtained directly from the data source. In other embodiments, the data is obtained via a network (e.g., the network 108 shown in FIG. 1). In one or more embodiments, prior to analysis of the data points, a determination is made as to the number of data points that should be obtained before analysis of the data begins. In one or more embodiments, the analysis begins immediately. In other embodiments, an initial threshold number of data points (e.g., ten, one hundred, one thousand, one million, etc.) is configured to be obtained before the analysis begins. The initial threshold number of data points to be obtained before the analysis begins may be configured as any number without departing from the scope of embodiments disclosed herein. In one or more embodiments, the initial threshold number of data points to be obtained before the analysis begins is based at least in part on the type of data being obtained, the amount of time and/or resources to be expended on the online experiment, and/or the type of result being sought (e.g., a prediction, an inference, an average, etc.). In one or more embodiments, the number of data points to be obtained prior to analysis of the data is configurable.

In Step 202, analysis of the data begins. Analysis of the data may be performed, for example, by a data analyzer (e.g., the data analyzer 104 shown in FIG. 1) of a computing device (e.g., the computing device shown in FIG. 1, or the computing device 300 shown in FIG. 3). In one or more embodiments, in Step 202, the analysis includes a determination as to whether the sample of data points obtained in Step 200 has a characteristic of being constant. In one or more embodiments, data has the characteristic of being constant if each data point is the same (e.g., a same numerical value). In one or more embodiments, data has the characteristic of being constant if each data point is within a given threshold. As an example, if all data points are within two percent of a value, such as all values being between 98 and 102, which are within two percent of one hundred, then the data may be determined to be constant. In one or more embodiments, if the data is determined to be constant, the method proceeds to Step 214. In one or more embodiments, if the data not determined to be constant, the method proceeds to Step 204.

In Step 204, the data analysis continues with a determination as to whether the sample of data points is monotonic. As used herein, monotonic refers to data that has a characteristic of continuously increasing or decreasing. In one or more embodiments, monotonic data may increase or decrease towards a limit (e.g., 4, 4.5, 4.7, 4.9, 4.95, 4.98 may be increasing to a limit of 5), which may be referred to as converging on the limit. In one or more embodiments, monotonic data may increase or decrease with no limit. In one or more embodiments, if the data is determined to have a characteristic of being monotonic, the method proceeds to Step 214. In one or more embodiments, if the data is determined not to have a characteristic of being monotonic, the method proceeds to Step 206.

In Step 206, the data analysis continues with a determination as to whether the data is normally distributed (e.g., has a Gaussian distribution). As used herein, a normal distribution may refer to either data that is normally distributed, or to data for which the logarithm of the data points is normally distributed. In one or more embodiments, a normal distribution is a distribution of data around a mean for which a standard deviation may be derived. In one or more embodiments, if the data is determined to have a characteristic of being normally distributed, the method proceeds to Step 214. In one or more embodiments, if the data is determined not to have a characteristic of being normally distributed, the method proceeds to Step 208.

In Step 208, the data analysis continues with a determination as to whether the data has a characteristic of being modal. Data may be unimodal, but not normally distributed. As an example, the data may be unimodal with a long tail distribution. Unimodal data may be data that has a clear peak at a most frequently occurring value (e.g., a mode). In one or more embodiments, the data may be multimodal. In one or more embodiments, multimodal data, as used herein, is data that has two or more modes. In one or more embodiments, if the data is determined to have a characteristic of being modal, the method continues to Step 214. In one or more embodiments, if the data is determined not to have a characteristic of being modal, the method proceeds to Step 210.

In Step 210, the data analysis continues with a determination as to whether the data has a characteristic of being autocorrelated. In one or more embodiments, autocorrelated data is data that has a characteristic of having some degree of similarity from one time period to another time period. For example, a time series of data points representing traffic at a website for one day may be determined to be autocorrelated if the data for the one day exhibits similarity with the pattern of traffic seen on some number of subsequent days (e.g., each day website traffic is lower during night time in a particular country and then increases during daytime in the particular country). In one or more embodiments, if data is determined to have a characteristic of being autocorrelated, the method proceeds to Step 214. In one or more embodiments, is the data is determined not to have a characteristic of being autocorrelated, the method proceeds to Step 212.

In Step 212, a determination is made as to whether a maximum run time has elapsed for the online experiment. In one or more embodiments, a maximum run time may be a configurable threshold for how long an online experiment should continue. The threshold may be an amount of time, an amount of data, or a combination thereof. The maximum run time may be configured based on any one or more of a variety of factors, which may include, but are not limited to, an amount of resources (e.g., cost, compute resources, etc.) available for conducting the online experiment; an amount of time (e.g., when a result is needed before a certain time after which the result becomes irrelevant), etc. In one or more embodiments, if the maximum run time has elapsed, the method proceeds to Step 216. In one or more embodiments, if the maximum run time has not elapsed, the method proceeds to Step 214.

In Step 214, a determination is made as to whether a convergence criterion is met. In one or more embodiments, as used herein, a convergence criterion is any metric that hay be ascertained about a sample of data points that indicates that the data is capable of providing a desired result. In one or more embodiments, the convergence criterion depends, at least in part, on one or more characteristics of the data sample as determined in Steps 202-212.

As an example, if the data is determined to have a characteristic of being constant, a convergence criterion may be a determination as to whether at least a threshold number of data points have been obtained that are constant. In one or more embodiments, if the threshold number of data points has been reached, the confidence criterion is met.

As another example, if the data is determined to have a characteristic of being monotonic, the convergence criterion may include a determination as to whether the data is approaching a limit or not. If the monotonic data is approaching a limit, the convergence criterion may further include a determination as to whether the data has approached within a certain threshold of the limit. In one or more embodiments, if the data is within the threshold, the confidence criterion is met. In one or more embodiments, if the data is determined not to be converging on a limit (e.g., it is increasing towards infinity), then the convergence criterion may further include a determination as to whether enough data points have been gathered to be sure that the data is not increasing or decreasing to a limit. In one or more embodiments, if enough data points have been gathered to be sure that the monotonic data is not converging on a limit, the convergence criterion is met.

As another example, if the data is determined to have a characteristic of being normally distributed, the convergence criterion may include applying hypothesis testing, or determining whether the width of the confidence interval for the mean of median falls below a threshold. In one or more embodiments, if the mean or median of the normal distribution is within the desired confidence level, the convergence criterion is met.

As another example, if the data is determined to have a characteristic of being modal the convergence criterion may include using any of a variety of techniques appropriate for unimodal or multimodal data. Such techniques may include, but are not limited to, using a regression model, such as a Gaussian mixture model, Gaussian process regression, Bayesian linear regression, kernel density estimation, etc. For such models, the convergence criterion may include determining if a Mean Integrated Squared Error (MISE) relative to the data distribution drops below a configurable threshold, or if, after a given number of data points, the MISE does not drop below the threshold after some number of new data points are added, either of which may indicate that a convergence criterion is met. Another technique that may be applied for modal data distributions is a clustering model, where a determination is made that, after a given number of samples, the number of clusters that best describe the data stops increasing, which indicates that the convergence criterion is met. Another technique that may be applied when the data is modal is using a machine-learning model that is trained to determine that enough data is obtained to be confident in the result obtained using the data obtained thus far. For example, a classification model may be trained using existing and/or synthetic data to predict a class of stop collecting data or continue collecting data. In one or more embodiments, if the machine-learning model predicts that data collection should stop, the convergence criterion is met. Another technique that may be applied when data is modal is using extreme value theory, where a convergence criterion may include determining if after a given number of samples, the modeled probability of observing an extreme value (e.g., an outlier) drops below a configurable threshold. In one or more embodiments, if the probability has dropped below the threshold, the convergence criterion is met.

One of ordinary skill in the art, having the benefit of this disclosure, will appreciate that other convergence criterion and/or other stopping rules or tests may be applied without departing from the scope of embodiments disclosed herein. In one or more embodiments, if the convergence criterion is not met, the method proceeds to Step 218. In one or more embodiments, if the convergence criterion is met, the method proceeds to Step 216.

In Step 216, the online experiment is stopped. In one or more embodiments, the online experiment is either stopped because the data exhibited one or more characteristics that corresponded to one or more stopping rules, and application of those one or more stopping rules revealed that a convergence criterion was met, or because the maximum run time for the online experiment has elapsed.

In Step 218, the method includes obtaining additional data, after which the method returns to Step 202 to re-analyze the data. The amount of additional data obtained may be configurable, and may be based at least in part on the data collected thus far, the one or more characteristics of the data obtained thus far, the stopping rule and corresponding convergence criteria used in Step 214, the time and resources remaining available for the online experiment, some combination of the aforementioned factors, etc.

Although FIG. 2 shows a variety of tests of data to determine if the data has certain characteristics being performed sequentially, in one or more embodiments, data that is determined to have a characteristic may be tested to determine if the data also has one or more additional characteristics. As an example, data that is determined to have a characteristic of being modal may also be tested over time to determine if the data is also autocorrelated. Whether data is tested for a variety of characteristics may be configured based on domain knowledge regarding the type of data, the nature of the online experiment, the result being sought, etc.

In one or more embodiments, obtaining additional data (e.g., as in Step 218) may include determining what to do with data already obtained. In one or more embodiments, the additional data is added to the data already obtained to obtain a larger data set to be analyzed as described above for various characteristics. As an example, data that was initially determined to have a constant distribution, but for which not enough data had been obtained to be confident in the constant value may, after more data is added to the data set, be determined to be monotonic. In one or more embodiments, at least some of the previously obtained data may be discarded. For example, the type of data, nature of the online experiment, etc. may dictate that a rolling window of data obtained over time should be used when testing for various characteristics. As an example, an occurrence of some event during the time the online experiment is being conducted may alter the possible characteristics of the data, and, therefore, it may be useful to discard data from prior to the event when determining characteristics of the data. As another example, it may be determined that outliers in the data should be discarded when analyzing the data.

In one or more embodiments, although FIG. 2 shows stopping the online experiment as a result of a convergence criterion being met, other techniques for making such a decision may be used. As an example, if more than one characteristic is determined to correspond to the data, more than one convergence criterion may be tested. In such scenarios, a majority voting rule may be used, where the online experiment is stopped if the majority of tested convergence criteria are met, or the various stopping rules and corresponding convergence criterion may be weighted based on observed data, or a strict policy may be enforced in which all relevant convergence criteria must be met to stop the online experiment.

FIG. 3 illustrates a block diagram of a computing device, in accordance with one or more embodiments of this disclosure. As discussed above, embodiments described herein may be implemented using computing devices. For example, the all or any portion of the components shown in FIG. 1 may be implemented, at least in part, using one or more computing devices. The computing device 300 may include one or more computer processors 302, non-persistent storage 304 (e.g., volatile memory, such as random access memory (RAM), cache memory, etc.), persistent storage 306 (e.g., a hard disk, an optical drive such as a compact disk (CD) drive or digital versatile disk (DVD) drive, a flash memory, etc.), a communication interface 312 (e.g., Bluetooth interface, infrared interface, network interface, optical interface, etc.), input devices 310, output devices 308, and numerous other elements (not shown) and functionalities. Each of these components is described below.

In one or more embodiments, the computer processor(s) 302 may be an integrated circuit for processing instructions. For example, the computer processor(s) may be one or more cores or micro-cores of a processor. The processor 302 may be a general-purpose processor configured to execute program code included in software executing on the computing device 300. The processor 302 may be a special purpose processor where certain instructions are incorporated into the processor design. Although only one processor 302 is shown in FIG. 3, the computing device 300 may include any number of processors without departing from the scope of embodiments disclosed herein.

The computing device 300 may also include one or more input devices 310, such as a touchscreen, keyboard, mouse, microphone, touchpad, electronic pen, motion sensor, or any other type of input device. The input devices 310 may allow a user to interact with the computing device 300. In one or more embodiments, the computing device 300 may include one or more output devices 308, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 302, non-persistent storage 304, and persistent storage 306. Many different types of computing devices exist, and the aforementioned input and output device(s) may take other forms. In some instances, multimodal systems can allow a user to provide multiple types of input/output to communicate with the computing device 300.

Further, the communication interface 312 may facilitate connecting the computing device 300 to a network (not shown) (e.g., a local area network (LAN), a wide area network (WAN) such as the Internet, mobile network, or any other type of network) and/or to another device, such as another computing device. The communication interface 312 may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 312 may also include one or more Global Navigation Satellite System (GNSS) receivers or transceivers that are used to determine a location of the computing device 300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

All or any portion of the components of the computing device 300 may be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples of embodiments described herein. It will be understood by those skilled in the art (who also have the benefit of this disclosure) that one or more embodiments described herein may be practiced without these specific details, and that numerous variations or modifications may be possible without departing from the scope of the embodiments described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

In the above description of the figures, any component described with regard to a figure, in various embodiments described herein, may be equivalent to one or more same or similarly named and/or numbered components described with regard to any other figure. For brevity, descriptions of these components may not be repeated with regard to each figure. Thus, each and every embodiment of the components of each figure is incorporated by reference and assumed to be optionally present within every other figure having one or more same or similarly named and/or numbered components. Additionally, in accordance with various embodiments described herein, any description of the components of a figure is to be interpreted as an optional embodiment, which may be implemented in addition to, in conjunction with, or in place of the embodiments described with regard to a corresponding one or more same or similarly named and/or numbered component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Embodiments disclosed herein set forth systems and methods for automating a stopping decision making process for online experiments. The stopping decision process disclosed includes obtaining data in real time during an online experiment, dynamically analyzing the data to determine if the data exhibits one or more characteristics, selecting a stopping rule and corresponding convergence criterion to test based on the one or more characteristics of the data, and stopping the online experiment when it is determined that a convergence criterion is met. In one or more embodiments, the automated stopping decision making process can react dynamically to changes in the data, and allow for enough data to be collected to be confident in a result obtained based on the data, and also allow for the data collection to stop, thereby avoiding an unnecessary waste of time or other resources used during the online experiment data collection.

While embodiments discussed herein have been described with respect to a limited number of embodiments, those skilled in the art, having the benefit of this disclosure, will appreciate that other embodiments can be devised which do not depart from the scope of embodiments as disclosed herein. Accordingly, the scope of embodiments described herein should be limited only by the attached claims.

What is claimed is:

1. An apparatus, comprising:
one or more processors; and
one or more non-transitory computer readable media storing instructions which, when executed by the one or more processors, cause the one or more processors to:
obtain a pre-determined number of data points from an online experiment;
process the data points to determine whether the data points exhibit at least one characteristic;
select, in response to the data points exhibiting the at least one characteristic, a first stopping rule of a plurality of stopping rules, wherein the first stopping rule corresponds to the at least one characteristic;
apply the first stopping rule to determine whether a first convergence criterion is met; and
stop, when the first convergence criterion is met, the online experiment.

2. The apparatus of claim 1, wherein execution of the instructions further causes the one or more processors, when the first convergence criterion is not met, to:
obtain additional data points.

3. The apparatus of claim 2, wherein execution of the instructions further causes the one or more processors, after obtaining the additional data points, to:
determine that no characteristic is exhibited by the data points and the additional data points; and
stop the online experiment after a maximum run time elapses.

4. The apparatus of claim 1, wherein execution of the instructions further causes the one or more processors, before stopping the online experiment, to:
select, in response to data points exhibiting a second characteristic, a second stopping rule of the plurality of stopping rules, wherein the second stopping rule corresponds to the second characteristic; and
apply the second stopping rule to determine whether a second convergence criterion is met,
wherein the online experiment is stopped when the first convergence criterion and the second convergence criterion are met.

5. The apparatus of claim 1, wherein the at least one characteristic comprises the data points being constant, and the first convergence criterion comprises determining whether a number of the data points is above a threshold.

6. The apparatus of claim 1, wherein the at least one characteristic comprises the data points being monotonic, and the first convergence criterion comprises determining that the data points are within a threshold of a limit.

7. The apparatus of claim 1, wherein the at least one characteristic comprises the data points having a normal distribution, and the first convergence criterion comprises determining that a mean of the data points is within a confidence interval of a specified maximal width.

8. The apparatus of claim 1, wherein the at least one characteristic comprises the data points being modal, and the first convergence criterion comprises applying a regression model or a clustering model.

9. The apparatus of claim 1, wherein the at least one characteristic comprises the data points being autocorrelated.

10. A computer-implemented method, comprising:
obtaining, by a processing device, a pre-determined number of data points from an online experiment;
processing, by the processing device, the data points to determine whether the data points exhibit at least one characteristic;
selecting, by the processing device and in response to the data points exhibiting the at least one characteristic, a first stopping rule of a plurality of stopping rules, wherein the first stopping rule corresponds to the at least one characteristic;
applying, by the processing device, the first stopping rule to determine whether a first convergence criterion is met; and
stopping, when the first convergence criterion is met, the online experiment.

11. The method of claim 10, further comprising, when the first convergence criterion is not met:
obtaining additional data points.

12. The method of claim 11, further comprising, after obtaining the additional data points:
determining that no characteristic is exhibited be the data points and the additional data points; and
stopping the online experiment after a maximum run time elapses.

13. The method of claim 10, further comprising, before stopping the online experiment:
selecting, in response to data points exhibiting a second characteristic, a second stopping rule of the plurality of stopping rules, wherein the second stopping rule corresponds to the second characteristic; and
applying the second stopping rule to determine whether a second convergence criterion is met,
wherein the online experiment is stopped when the first convergence criterion and the second convergence criterion are met.

14. The method of claim 10, wherein the at least one characteristic comprises the data points being constant, and the first convergence criterion comprises determining whether a number of the data points is above a threshold.

15. The method of claim 10, wherein the at least one characteristic comprises the data points being monotonic, and the first convergence criterion comprises determining that the data points are within a threshold of a limit.

16. The method of claim 10, wherein the at least one characteristic comprises the data points having a normal distribution, and the first convergence criterion comprises determining that a mean of the data points is within a confidence interval of a specified maximal width.

17. The method of claim 10, wherein the at least one characteristic comprises the data points being modal, and the first convergence criterion comprises applying a regression model or a clustering model.

18. The method of claim 10, wherein the at least one characteristic comprises the data points being autocorrelated.

19. A non-transitory computer-readable medium storing programming for execution by one or more processors, the programming comprising instructions to:
obtain, by a processing device, a pre-determined number of data points from an online experiment;
process, by the processing device, the data points to determine whether the data points exhibit at least one characteristic;
select, by the processing device and in response to the data points exhibiting the at least one characteristic, a first stopping rule of a plurality of stopping rules, wherein the first stopping rule corresponds to the at least one characteristic;
apply, by the processing device, the first stopping rule to determine whether a first convergence criterion is met; and
stop, when the first convergence criterion is met, the online experiment.

20. The non-transitory computer-readable medium of claim 19, wherein the programming comprises further instructions, when the first convergence criterion is not met, to obtain additional data points.
